(19) United States
(12) Patent Application Publication
(10) Pub. No.: US 2007/0289798 A1
(43) Pub. Date: Dec. 20, 2007

(54) Sideloader forklift with all wheel steering

(76) Inventor: Manfred Kaufmann, Elburn, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/454,237

(22) Filed: Jun. 17, 2006

(51) Int. Cl. B60K 17/30

(52) U.S. Cl. 180/253; 180/411

(57) ABSTRACT

A forklift apparatus with improved all-wheel steering includes: a chassis; a plurality of wheels; at least one motor; a plurality of idler pulleys; a plurality a traction belts; and a plurality of actuators. The plurality of wheels supports the chassis from a ground surface and steer the chassis on the ground surface. The at least one motor is operatively connected to at least one of the wheels to rotate the wheel about a horizontal axis. Each wheel is rotationally mounted to the chassis about a vertical axis. Each wheel has a drive pulley oriented horizontally above the wheel and centered on the axis and connected to rotate with the wheel about the vertical axis. Each idler pulley is rotationally mounted to the chassis about a vertical axis and spaced from one of the drive pulleys. Each traction belt is wrapped around one pair comprising an idler pulley and a drive pulley. Each actuator includes a drive element and is connected to one of the traction belts, wherein movement of the drive element in a first direction causes circulation of the traction belt in a first circulating direction, and movement of the drive element in a second, opposite direction causes circulation of the traction belt in a second, opposite circulating direction.

### TECHNICAL FIELD OF THE INVENTION

This invention relates to all-wheel vehicle steering. Particularly, this invention is directed to an all-wheel steering system for a sideloader forklift truck.

### BACKGROUND OF THE INVENTION

In some warehouse operations, a sideloader forklift truck capable of maneuvering along and within a narrow aisle is used to retrieve and deposit loads, usually on multi-tier racks.

An example of such a lift truck is a BAUMANN® ElectricFourway-Sideloader Series EVU 20/25/30 available from Baumann Handling Systems, Inc., of Yorkville, Ill., USA. U.S. Pat. No. 3,067,839 also describes a sideloader truck, herein incorporated by reference.

A typical prior art electric sideloader forklift truck 20 is illustrated schematically in FIGS. 1-3. The sideloader includes four wheels 22, 24, 26, 28 that support aprone U-shaped chassis 32 from a floor surface. The chassis includes a longitudinally extended base 33 and laterally extended legs 34, 35. The chassis 32 supports a hydraulic forklift assembly 36.

For purposes of orientation of the description herein, the chassis 32 has a front end 42 having a front end edge 42a, a rear end 44 having a rear end edge 44a, a rack side or fork side 46 having a rack side edge 46a, and a cab side 48 having a cab side edge 48a. The rack side 46 is the side which must approach a rack for loading and unloading articles passing across the rack side edge 46a using the forklift assembly 36. A cab 52 is arranged on the base 33 along the cab side edge and along the rear end edge. Batteries 56 are arranged within a cabinet 57 arranged on the base 33 along the cab side 48 adjacent to the cab 52. An end cabinet 58 for containing the electronics and hydraulics is provided adjacent to the batteries, along the cab side 48 and along the front end 42.

The cab side wheels 22, 24 are driven by motors 59, 60. The cab side wheels are driven and steerable wheels such as described in U.S. Pat. No. 3,163,250.

The forklift assembly 36 includes a frame-like mast 64 that supports a fork 66 having a longitudinally extended cross beam 67 and two laterally extended tines 68, 70 extending from the cross beam 67. The cross beam 67 is guided for vertical movement on the mast 64 and supported vertically by a hydraulic cylinder 76 connected to the mast. The hydraulic cylinder 76 is used to selectively raise-and-lower the fork 66. The fork 66 is shown supporting a load 78 being loaded onto, or unloaded from, a rack 82. In this regard, the mast 64 is guided for horizontal translation on the chassis 32 by rollers (not shown) that move in guide tracks 90, 92 arranged in the legs 35, 36 of the chassis 32. The mast is translated horizontally toward and away from the edge 46a by one or more hydraulic cylinders (not shown).

Room for electric components, electronics, a hydraulic tank and the drive motor 60 is created at the opposite end from the cab, within the end cabinet 58.

Because of the narrow areas in which sideloaders must operate, it is advantageous for such sideloaders to have highly maneuverable steering.

FIGS. 7-12 illustrate prior art methods of forklift steering.

FIG. 7 discloses a forklift steering arrangement having four wheels A, B, C, D. Wheel A is the forklift drive wheel that is also steerable with an ORBITROL. Wheels B and D were free-wheeling caster, trolley wheels. These wheels are caused to rotate and steer merely by differential force between the forklift and the ground surface, i. e., there is no operator-controlled drive or steering at these wheels. Wheel C is not driven for traction but is steered using a hydraulic cylinder that turns a pivot lever associated with the wheel.

A further prior art forklift steering arrangement is illustrated in FIG. 8. According to this arrangement, wheels A and D are each driven by a motor and are each steered with an ORBITROL and a common hydraulic cylinder. A figure 8 chain wraps the respective ORBITROL, and a hydraulic cylinder is associated with one straight run of the figure 8 chain, such that movement of the hydraulic cylinder rod turns wheels A and D accordingly. Wheel B is a free-wheeling caster, trolley wheel. Wheel C is not driven for traction but is steered using a hydraulic cylinder that turns a pivot lever associated with the wheel.

A further prior art forklift steering arrangement is illustrated in FIG. 9. According to this arrangement, wheels A and D are each driven by a motor and are each steered with an ORBITROL and a hydraulic cylinder. A figure 8 chain wraps the respective ORBITROL, and a hydraulic cylinder is associated with one straight run of the figure 8 chain such that movement of the hydraulic cylinder rod turns wheels A and D accordingly. Wheels B and C are individually steered with hydraulic motors driving chains which turn pivot axes of the respective wheels. Wheels B and C are not driven for traction. The hydraulic motors and the hydraulic cylinder or controlled by a computer taking steering instructions from the operator.

A further prior art forklift steering arrangement is illustrated in FIG. 10. According to this arrangement, wheels A and D were each driven by a motor and are steered with hydraulic motors driving chains which turn pivot axes of the respective wheels. Wheels B and C are steered with hydraulic motors driving chains which turn pivot axes of the respective wheels. Wheels B and C are not driven for traction. The hydraulic motors are controlled by a computer taking steering instructions from the operator.

A further prior art forklift steering arrangement is illustrated in FIG. 11. According to this arrangement only three wheels A, B, C are used. This arrangement features diesel or LPG propulsion and is intended for outdoor use. The arrangement uses SUPER ELASTIC tires. SUPER ELASTIC tires generate high friction needed for outdoor use. All three wheels are driven for four-directional maneuverability. Each wheel is steered by use of a separate steer cylinder that pivots a solid plate, pivot lever.

The present inventor has recognized the disadvantages of the above steering systems. The steering systems of FIGS. 7 and 8 have limited steering capabilities due to the limits of movement of the hydraulic cylinder turning the pivot lever at wheel C. The steering system of FIG. 8 also has a lack of steering flexibility due to the wheels A and D connected together to turn in synchronism. This is also true for the steering system shown in FIG. 9. Because the wheels A and D are connected, if the truck was moving toward the rack side 46, only the wheels B and C could be steered. This is a distinct disadvantage, since forklifts typically have their steering at the cab side 48 for better maneuverability.

The present inventor has recognized that the steering system of FIG. 10 suffers the drawback in that the hydraulic motors provide limited turning force. For sideloaders used indoors on smooth floors, the hydraulic motors may be sufficient. The trucks have polyurethane or solid rubber tires. These tires, in conjunction with the smooth floors, will not develop much friction and therefore, hydraulic motors are usually sufficient to turn the wheels. Trucks with heavier capacity are typically built with dual wheel design. FIG. 12 shows a dual steer wheel design. According to this design the differential rotation of the wheels causes turning of the wheel assembly. However, the dual wheel design cannot turn on the spot, they roll on the floor during turning. However, four-directional sideloaders need to change steering direction from a standstill. This is where the most force is needed to overcome friction to turn the wheels.

The present inventor has recognized that the hydraulic motor design has another drawback. When negotiating potholes, or railroad crossings, which can exist in some indoor applications, the hydraulic motor/chain design does not have the precision and force needed to hold the wheel exactly in place, slippage causing deviations in the steering function.

The present inventor has recognized that the steering design of FIG. 11 suffers the draw back that when the truck is driven from back 44 to front 42, or vise versa from front 42 to back 44, the truck has difficulty making a turn when turning toward the forks (toward the rack side 46), since the steer cylinders for wheels B and C are limited in stroke, in other words, the cylinders reach an end of travel.

### SUMMARY OF THE INVENTION

The invention provides an improved all-wheel steering for a vehicle, particularly for a sideloader forklift truck. The all-wheel steering system includes: a chassis; a plurality of wheels; at least one motor; a plurality of idler pulleys; a plurality a traction belts; and a plurality of actuators. The plurality of wheels supports the chassis from a ground surface and steer the chassis on the ground surface. The at least one motor is operatively connected to at least one of the wheels to rotate the wheel about a horizontal axis. Each wheel is rotationally mounted to the chassis about a vertical axis. Each wheel has a drive pulley oriented horizontally above the wheel and centered on the axis and connected to rotate with the wheel about the vertical axis. Each idler pulley is rotationally mounted to the chassis about a vertical axis and spaced from one of the drive pulleys. Each traction belt is wrapped around one pair comprising an idler pulley and a drive pulley. Each actuator includes a drive element and is connected to one of the traction belts, wherein movement of the drive element in a first direction causes circulation of the traction belt in a first circulating direction, and movement of the drive element in a second, opposite direction causes circulation of the traction belt in a second, opposite circulating direction.

According to one exemplary embodiment, the drive pulleys comprise chain sprockets, the idler pulleys comprises chain sprockets and the traction belts comprise drive chains.

According to one exemplary embodiment, the actuators comprise hydraulic cylinders.

According to one exemplary embodiment, each of the wheels is driven by a separate motor.

According to one exemplary embodiment, only one of the wheels is driven by a motor.

According to one exemplary embodiment, the plurality of wheels comprises only four wheels.

According to one exemplary embodiment, the plurality of wheels comprises only three wheels.

According to another aspect of the invention a forklift truck, preferably a sideloader forklift truck, includes: a chassis; a plurality of wheels; at least one motor; a plurality of idler pulleys; a plurality a traction belts; a plurality of actuators and a forklift mechanism. The plurality of wheels supports the chassis from a ground surface and steers the chassis on the ground surface. The at least one motor is operatively connected to the at least one wheel to rotate the wheel about a horizontal axis. Each wheel is rotationally mounted to the chassis about a vertical axis. Each wheel has a drive pulley oriented horizontally above the wheel, is centered on the vertical axis, and is connected to rotate with the wheel about the vertical axis. Each idler pulley is rotationally mounted to the chassis about a vertical axis and is spaced from one of the drive pulleys. Each traction belt is wrapped around one pair comprising an idler pulley and a drive pulley. Each actuator has a drive element and is connected to one of the traction belts, wherein movement of the drive element in a first direction causes circulation of the traction belt in a first circulating direction, and movement of the drive element in a second, opposite direction causes circulation of the traction belt in a second, opposite circulating direction. The forklift mechanism is carried by the chassis and oriented to load articles on, and unload articles from, the forklift truck.

According to one exemplary embodiment, the drive pulleys comprise chain sprockets, the idler pulleys comprise chain sprockets and the traction belts comprise drive chains.

According to one exemplary embodiment, the actuators comprise hydraulic cylinders.

According to one exemplary embodiment, each of the wheels is driven by a separate motor.

According to one exemplary embodiment, only one of the wheels is driven by a motor.

According to one exemplary embodiment, the plurality of wheels comprises only four wheels.

According to one exemplary embodiment, the plurality of wheels comprises only three wheels.

According to one exemplary embodiment, the chassis comprises a U-shape, and the plurality of wheels comprises four wheels arranged in a rectangular pattern.

The invention provides all-wheel steering, particularly for a sideloader forklift truck that can generate sufficient turning torque at each wheel to overcome turning friction. The invention provides all-wheel steering that provides an independently controllable steering at each wheel for increased turning flexibility. The invention provides all-wheel steering that is rugged and holds a precise steering position even when driving over potholes or other terrain or obstacles. The steering system is capable of precisely steering the truck even when equipped with large tires for high capacity loads. The invention provides a truck that is capable of making tight turns in any direction. The truck is capable of turning within its own length and performs “crab steering” or diagonal movement of the truck.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a schematic perspective view of a prior art sideloader forklift truck delivering a load of elongated articles onto a rack;

FIG. 2 is a schematic top plan view of the sideloader forklift truck shown in FIG. 1;

FIG. 3 is a schematic side elevation view of the sideloader forklift truck shown in FIG. 1;

FIG. 4 is a schematic top plan view of a sideloader forklift truck of the present invention;

FIG. 5 is a schematic side elevation view of the sideloader forklift truck shown in FIG. 4;

FIG. 6 is a schematic plan view of a steering system of the sideloader forklift truck shown in FIG. 4;

FIG. 6A is a schematic plan view of an alternate embodiment steering system;

FIG. 7 is a schematic plan view of a steering system of a prior art forklift truck;

FIG. 8 is a schematic plan view of a steering system of a prior art forklift truck;

FIG. 9 is a schematic plan view of a steering system of a prior art forklift truck;

FIG. 10 is a schematic plan view of a steering system of a prior art forklift truck;

FIG. 11 is a schematic plan view of a steering system of a prior art forklift truck; and

FIG. 12 is a schematic plan view of a portion of a steering system of a prior art forklift truck.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

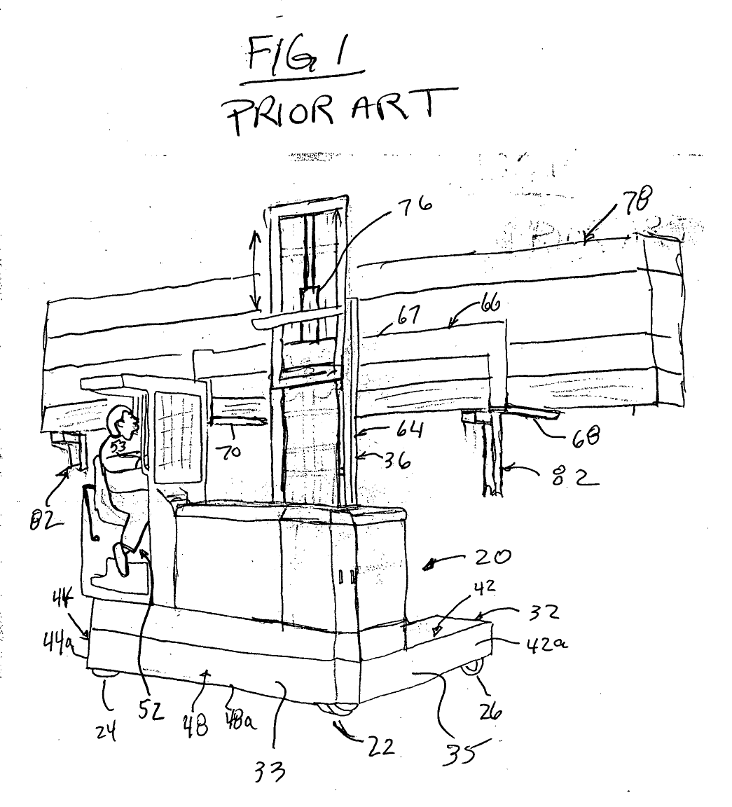

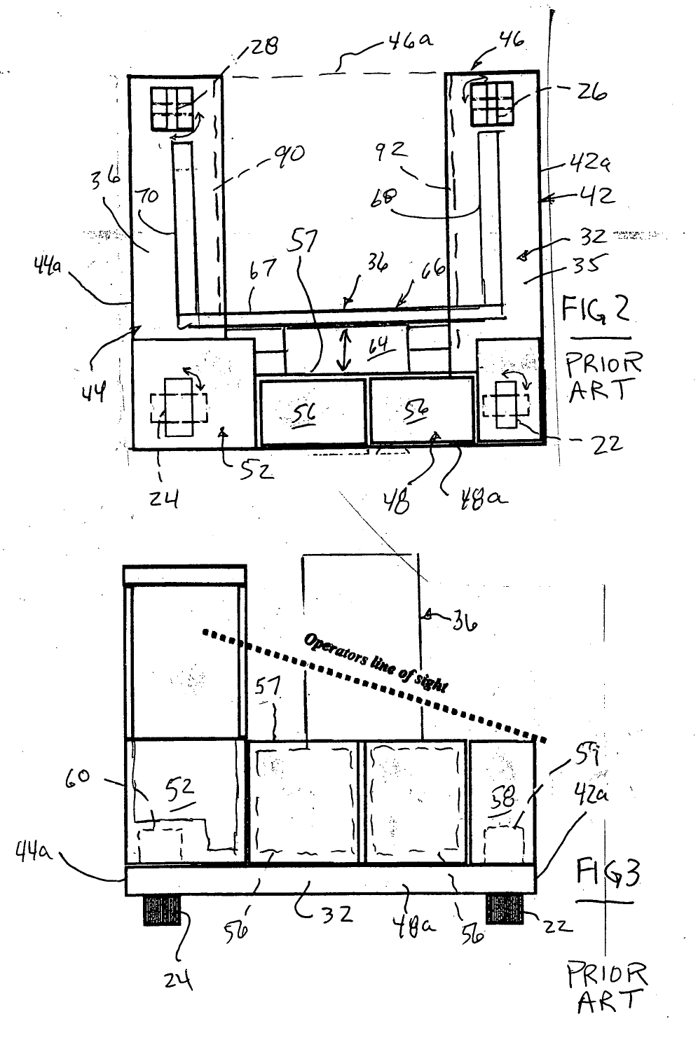

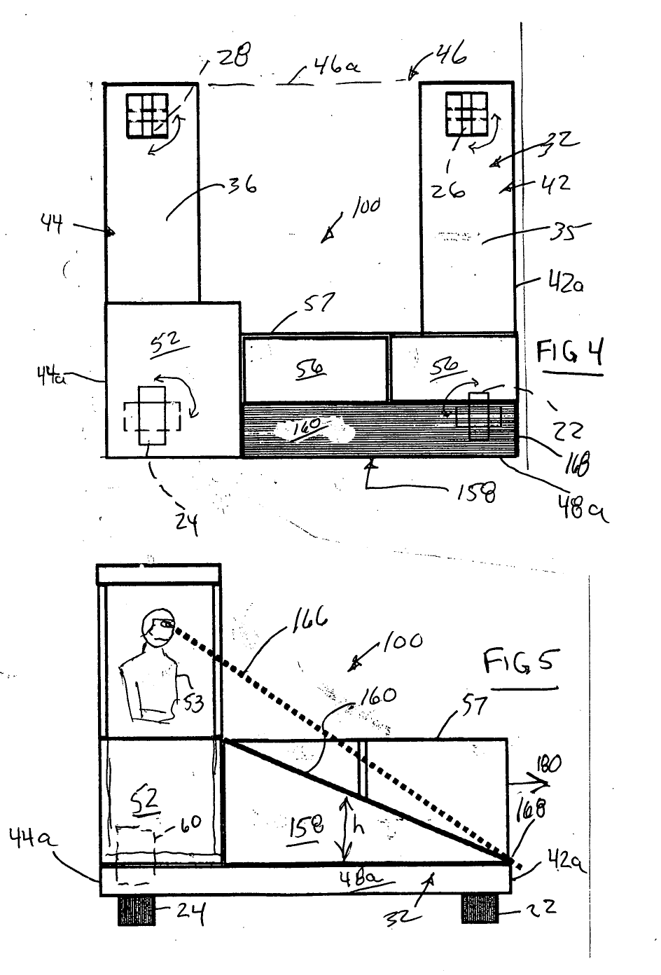

FIGS. 4 and 5 illustrate a sideloader forklift truck 100 of the present invention. Elements that are common to the prior art sideloader forklift truck described in FIGS. 1-3 carry identical reference numbers. The forklift assembly 36 is not shown in FIGS. 4 and 5 for simplicity but would be identical to that shown in FIGS. 1-3.

The sideloader forklift truck 100 is described more completely in the co-pending patent application U.S. Ser. No. ______, naming the same inventor, filed on the same day as the present application, and identified by attorney docket number 6681P0010US, herein incorporated by reference.

The sideloader forklift truck 100 includes batteries 56 that are arranged in the cabinet 57 set back from the chassis cab side edge 48a. The end cabinet 58 shown in FIGS. 1-3 is replaced by a side cabinet 158 that is located adjacent to the edge 48a. The side cabinet 158 has a varying height “h” that is decreasing from the cab 52 toward the front end edge 42a.

According to the preferred embodiment, the height “h” decreases linearly, forming a tapered cabinet with a slanted cabinet top wall 160.

By tapering the cabinet 158 from the cab 52 to the front end edge 42a, the operator 53 has an unobstructed line of sight 166 to a top edge portion 168 of the front end edge 42a, without moving his head outside of the cab 52.

The side cabinet 158 is configured to contain the hydraulic, electric components and electronic components to drive the forklift truck 100 and the forklift 36.

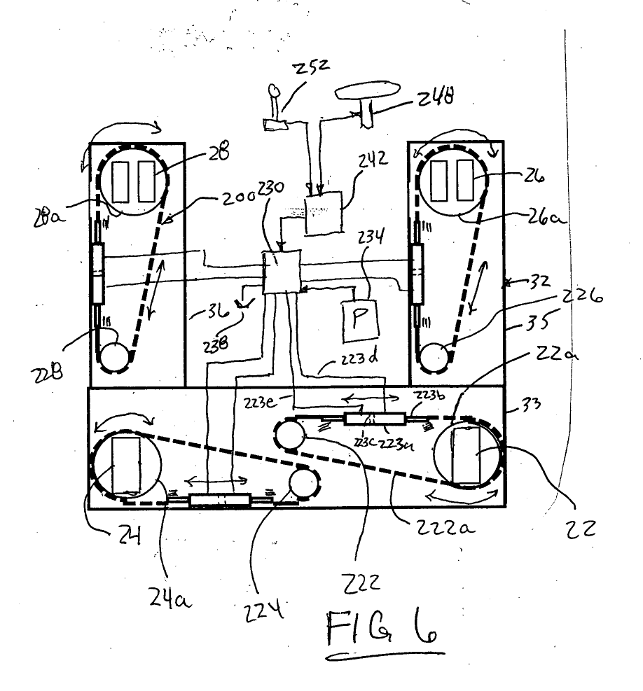

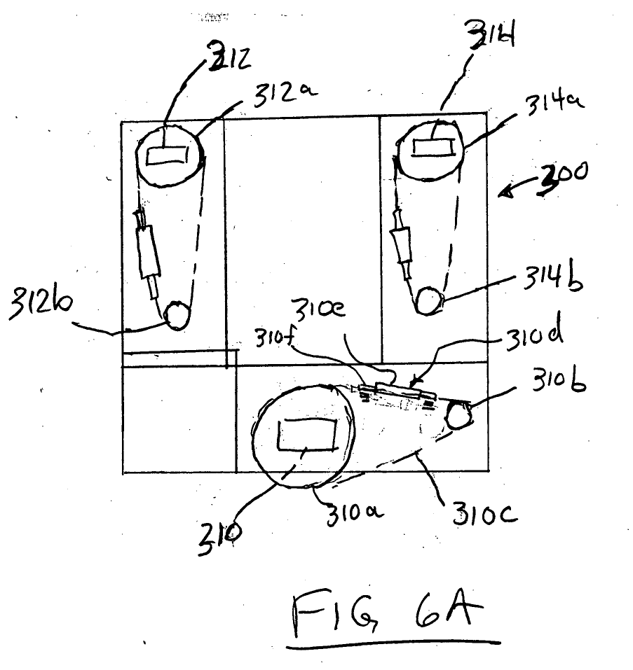

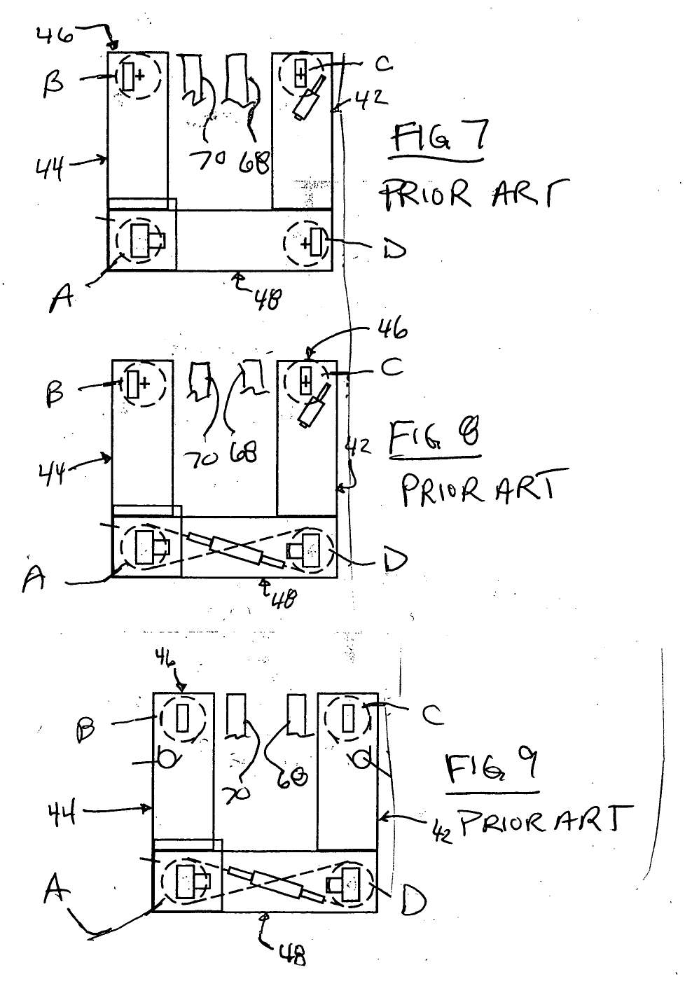

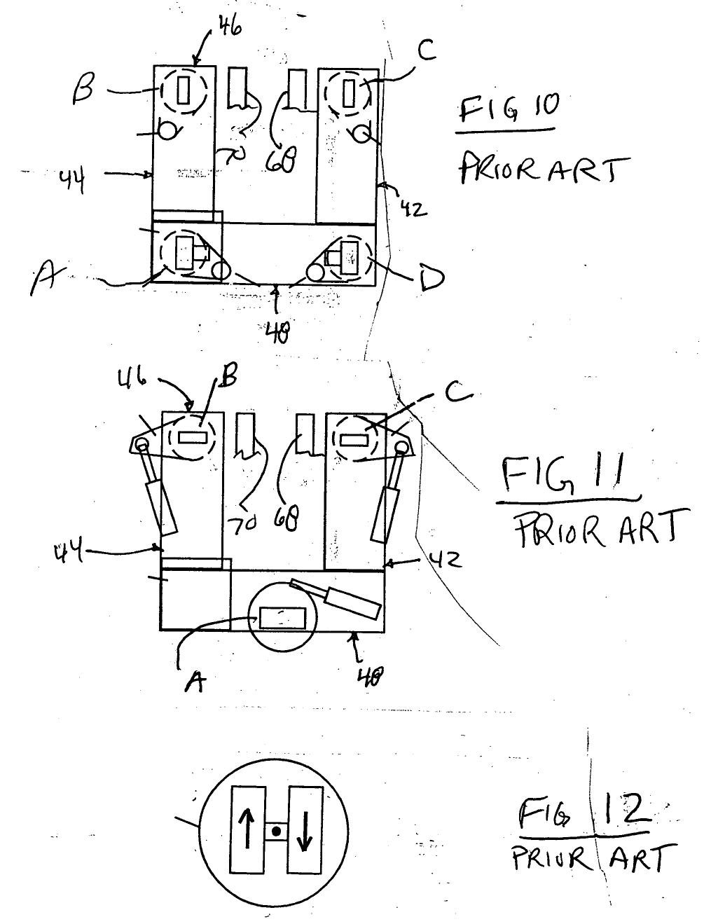

FIG. 6 illustrates a four-wheel steering system 200 according to another aspect of the invention. The wheels 22, 24, 26, 28 are steerable wheels and one or more of the wheels can be driven wheels such as provided in the BAUMANN® Electric-Fourway-Sideloader, Series EVU 20/25/30 available from Baumann Handling Systems, Inc., of Yorkville, Ill., USA or such as disclosed in U.S. Pat. Nos. 3,163,250; 3,698,504; 3,370,668; 4,461,367; 6,349,781; 6,367,571; or 6,854,552, all herein incorporated by reference.

The steering system 200 includes a drive pulley 22a for turning the cab side driven wheel 22, a drive pulley 24a for turning the cab side driven wheel 24, a drive pulley 26a for turning the rack side wheel 26, and a drive pulley 28a for turning the rack side wheel 28. An idler pulley 222 is arranged spaced from the drive pulley 22a. An idler pulley 224 is arranged spaced from the drive pulley 24a. An idler pulley 226 is arranged spaced from the drive pulley 26a. An idler pulley 228 is arranged spaced from the drive pulley 28a.

A drive traction belt 222a is wrapped around the drive pulley 22a and the idler pulley 222. An actuator, such as a dual acting hydraulic cylinder 222b includes a cylinder portion 223a, a dual acting rod 223b that penetrates through the cylinder portion 223a and is connected at an intermediate position to a piston 223c within the cylinder portion 223a. The rod is exposed on opposite ends outside of the cylinder portion. The cylinder portion 223a is fastened to the drive traction belt 222a. The opposite ends of the rod 223b are fastened to stationary structure of the chassis 32. Alternatively, the rod 223 be can be fastened to the drive traction belt 222a and the cylinder portion 223a can be fastened to stationary structure of the chassis 32. Hydraulic fluid communicates through hydraulic lines 223d, 223e into the cylinder portion 223a on opposite sides of the piston 223c. Depending on the differential pressure within the lines 223d, 223e, the cylinder portion 223a will slide along the rod 223b in a selected direction. Movement of the cylinder portion 223a will cause circulation of the drive traction belt 222a in a selected direction. Circulation of the drive traction belt 222a will then cause turning of the drive pulley 22a and turning of the wheel 22.

Each of the other drive pulley and idler pulley pairs 24a, 224; 26a, 226; and 28a, 228 is wrapped by a respective drive traction belt and includes a hydraulic cylinder and an associated hydraulic circuit all arranged in the same configuration as that described above for the drive pulley/idler pulley pair 22, 222. Operation of the hydraulic cylinders for turning the respective wheel 24, 26, 28 is the same as that described for turning the wheel 22.

According to the preferred embodiments, the drive pulleys and the idler pulleys are in the form of toothed chain sprockets and the traction belts are in the form of drive chains. The drive chain is preferably a FLYER chain having a high tensile strength and minimum overall strain (lengthening) in operation.

All of the hydraulic lines, such as 223d, 223e, are in fluid communication with a hydraulic valve network 230. The valve network can be a solenoid-controlled spool valve manifold that is electronically controlled. The valve network receives pressurized hydraulic fluid from a hydraulic pump 234 and is in selective fluid communication with a low pressure return line to a hydraulic reservoir 238.

The hydraulic valve network 230 is in signal-communication with an electronic controller 242. Electronic controller 242 receives as input signals the operator-selected traction direction, such as from a steering wheel 248 or like device and a direction selection lever 252.

The electronic controller is pre-programmed to convert the input signals to a corresponding output signal to the valve network to turn each of the four wheels 22, 24, 26, 28 to the correct angle. An example of a four-wheel steering control using an electronic controller controlling a hydraulic circuit to each wheel is described in U.S. Pat. No. 5,718,304 and is herein incorporated by reference.

According to one aspect of the present invention, the present inventor has recognized that a single motor 60 (FIG. 5) associated with drive wheel 24 is sufficient to drive the sideloader forklift truck under most circumstances. The further drive motor 59 can be eliminated while maintaining an effectively operable sideloader forklift truck. Therefore, the end cabinet 58 shown in prior art FIG. 3 that accommodated the further drive motor 59 can be eliminated as well. A more compact side loader forklift truck is possible with the unobstructed driver's sight line 166, given the relocation of the batteries 56 and the provision of the tapered side cabinet 158.

FIG. 6A illustrates an alternate embodiment a forklift truck steering system 300 having three wheels 310, 312, 314. The wheels 310, 312, 314 are steerable wheels and one or more of the wheels can be driven wheels such as provided in the BAUMANN® Electric-Fourway-Sideloader Series EVU 20/25/30 available from Baumann Handling Systems, Inc., of Yorkville, Ill., USA or such as disclosed in U.S. Pat. Nos. 3,163,250; 3,698,504; 3,370,668; 4,461,367; 6,349,781; 6,367,571; or 6,854,552, all herein incorporated by reference. Preferably, all three wheels are driven by three respective motors, and also steered according to the steering arrangement of the present invention.

The steering system 300 includes a drive pulley 310a for turning the cab side driven wheel 310, a drive pulley 312a for turning the rack side wheel 312, and a drive pulley 314a for turning the rack side wheel 314. An idler pulley 310b is arranged spaced from the drive pulley 310a An idler pulley 312b is arranged spaced from the drive pulley 312a. An idler pulley 314b is arranged spaced from the drive pulley 314a A drive traction belt 310c is wrapped around the drive pulley 310a and the idler pulley 310b. An actuator, such as a dual acting hydraulic cylinder 310d includes a cylinder portion 310e, a dual acting rod 310f that penetrates through the cylinder portion 310e and is connected at an intermediate position to a piston within the cylinder portion 310e. The rod is exposed on opposite ends outside of the cylinder portion 310e. The cylinder portion 310e is fastened to the drive traction belt 310c. The opposite ends of the rod 310f are fastened to stationary structure of the chassis. Alternatively, the rod 310f can be fastened to the drive traction belt 310c and the cylinder portion 310e can be fastened to stationary structure of the chassis.

Each of the other drive pulley and idler pulley pairs 312a, 312b; and 314a, 314b is wrapped by a respective drive traction belt and includes a hydraulic cylinder and an associated hydraulic circuit all arranged in the same configuration as that described above for the drive pulley/idler pulley pair 310a, 310b.

According to the preferred embodiments, the drive pulleys and the idler pulleys are in the form of toothed chain sprockets and the traction belts are in the form of drive chains. The drive chain is preferably a FLYER chain having a high tensile strength and minimum overall strain (lengthening) in operation.

Operation of the hydraulic cylinders for turning the respective wheel 310, 312, 314 is the same as that shown and described for turning the wheel 22, particularly as shown and described with respect to FIG. 6.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An all-wheel steering system for a vehicle, comprising:
a chassis;
a plurality of wheels supporting said chassis from a ground surface and steering said chassis on said ground surface;
at least one motor operatively connected to at least one wheel to rotate said wheel about a horizontal axis;
each wheel rotationally mounted to said chassis about a vertical axis, and each wheel having a drive pulley oriented horizontally above said wheel and centered on said axis and connected to rotate with said wheel about said vertical axis;
a plurality of idler pulleys, each idler pulley rotationally mounted to said chassis about a vertical axis and spaced from one of said drive pulleys;
a plurality a traction belts, each traction belt wrapped around one pair comprising an idler pulley and a drive pulley; and
a plurality of actuators each having a drive element each actuator connected to one of said traction belts, movement of said drive element in a first direction causing circulation of said traction belt in a first circulating direction and movement of said drive element in a second, opposite direction causing circulation of said traction belt in a second, opposite circulating direction.

2. The all-wheel steering system according to claim 1, wherein said drive pulley comprises a chain sprocket, said idler pulley comprises a chain sprocket and said traction belt comprises a drive chain.

3. The all-wheel steering system according to claim 2, wherein said actuator comprises a hydraulic cylinder.

4. The all-wheel steering system according to claim 3, wherein each of said wheels is driven by a separate motor.

5. The all-wheel steering system according to claim 4, wherein only one of said wheels is driven by a motor.

6. The all-wheel steering system according to claim 3, wherein said plurality of wheels comprises only four wheels.

7. The all-wheel steering system according to claim 3, wherein said plurality of wheels comprises only three wheels.

8. The all-wheel steering system according to claim 1, wherein said plurality of wheels comprises only four wheels.

9. The all-wheel steering system according to claim 1, wherein said plurality of wheels comprises only three wheels.

10. A forklift truck, comprising:
a chassis;
a plurality of wheels supporting said chassis from a ground surface and steering said chassis on said ground surface;
at least one motor operatively connected to at least one wheel to rotate said wheel about a horizontal axis;
each wheel rotationally mounted to said chassis about a vertical axis, and each wheel having a drive pulley oriented horizontally above said wheel and centered on said axis and connected to rotate with said wheel about said vertical axis;
a plurality of idler pulleys, each idler pulley rotationally mounted to said chassis about a vertical axis and spaced from one of said drive pulleys;
a plurality a traction belts, each traction belt wrapped around one pair comprising an idler pulley and a drive pulley; and
a plurality of actuators each having a drive element, each actuator connected to one of said traction belts, movement of said drive element in a first direction causing circulation of said traction belt in a first circulating direction and movement of said drive element in a second, opposite direction causing circulation of said traction belt in a second, opposite circulating direction; and
a forklift mechanism carried by said chassis and oriented to load articles on, and unload articles from, said forklift truck.

11. The forklift truck according to claim 10, wherein said drive pulley comprises a chain sprocket, said idler pulley comprises a chain sprocket and said traction belt comprises a drive chain.

12. The forklift truck according to claim 11, wherein said actuator comprises a hydraulic cylinder.

13. The forklift truck according to claim 10, wherein each of said wheels is driven by a separate motor.

14. The forklift truck according to claim 10, wherein only one of said wheels is driven by a motor.

15. The forklift truck according to claim 14, wherein said plurality of wheels comprises only four wheels.

16. The forklift truck according to claim 10, wherein said plurality of wheels comprises only three wheels.

17. The forklift truck according to claim 10, wherein said plurality of wheels comprises only four wheels.

18. The forklift truck according to claim 10, wherein said chassis comprises a U-shape, and said plurality of wheels comprise four wheels arranged in a rectangular pattern.

19. The forklift truck according to claim 10, wherein said chassis comprises a U-shape, and said plurality of wheels comprise four wheels arranged in a rectangular pattern, said drive pulley comprises a chain sprocket, said idler pulley comprises a chain sprocket, said traction belt comprises a drive chain, said actuator comprises a hydraulic cylinder, and wherein only one of said wheels is driven by a motor.
